(19) United States
(12) Patent Application Publication
(10) Pub. No.: US 2002/0097555 A1
(43) Pub. Date: Jul. 25, 2002

(54) Small form factor computer

(76) Inventors: Mitchell A. Smith, Thousand Oaks, CA (US); Karsten Jeppesen, Odense (DK)

Correspondence Address: RALPH D CHABOT, 2310 E PONDEROSA DR, SUITE 4, CAMARILLO, CA, 93010, US

(21) Appl. No.: 09/784,222

(22) Filed: Jan. 19, 2001

(51) Int. Cl. G06F 1/16

(52) U.S. Cl. 361/683; 361/686

(57) ABSTRACT

A miniature high performance computer unit which can be inserted into an available drive slot in a computer enclosure and serve as a replacement for the computer's computational resource or serve as an additional computational resource. Industry standard drive slots will permit universal application thereby permitting the continued use of the purchased computer enclosure and greatly simplify future design considerations.

### BACKGROUND OF THE INVENTION

The present invention relates to computer hardware. Computer main boards, also known as motherboards, are designed and manufactured according to multiple standards and specifications that typically result in their non-uniform installation into computer cases and other target enclosures. This results in a standards deficiency since these motherboards, which are of varied configurations, are used in a manner that often times is not space efficient. This standards deficiency is evident in most desktop computer cases where a variety of adjustable attachment settings and fasteners are provided, in multiple places, to counter the wide disparity in motherboard geometric configuration existing in the marketplace.

Because of the wide disparity in the physical design of motherboards, product designers and developers are often faced with a perplexing dilemma in establishing the dimensional parameters for their products. More specifically, they find themselves unable to design enclosures or computer housings with adequate space and adjustment capabilities because the standards and specifications for next generation motherboards are yet to be determined.

For example, without the availability of prior standards, the designer of an automobile painting robot could inadvertently specify a computer enclosure that is noncompatible with the required motherboard. Likewise, an architect designing a regulatory or security computer into a building structure could invite major modification expense with a mismatch of motherboard and enclosure space. Multiprocessing and more specifically cluster processing is yet another example where the system or overall can be more effectively designed if the enclosure format for each processor is known rather than simply the motherboard format. For this type of situations, a more efficient use of space can be utilized if a standard housing unit is specified in advance instead of a variably sized motherboard configuration.

Traditionally, high performance desktop computers have been called computer workstations or more simply workstations. These workstations rely on custom motherboard designs, custom enclosures, custom power supplies and custom operating systems. This high level of customization results in higher costs to end-users. Almost every new version of the manufacturers workstation comes in a different case design or uses a motherboard of a different geometric configuration. This constant changing of sizes with changes in workstation design requires the users of these workstations to either continue using the old workstation or to redesign their product to adapt to the geometric configuration of the new workstation.

Accordingly, there is a need for a product, which provides the desired computer functions and high computational power in a uniform cabinet or housing unit.

### SUMMARY OF THE INVENTION

Our invention resolves the standards based deficiencies heretofore discussed in motherboard design and adaptation to an enclosure or housing unit.

One feature of the current invention is that it is a high performance single board computer that fits into an industry standard form factor space, which in the computer industry is termed a 5¼″ half-height drive bay. This drive bay typically supports such components as magnetic or optical disk drives.

The housing unit of our invention is appropriately sized to slide into the 5¼″ half-height drive bay. The housing unit has a rear panel which has sufficient external area so that various types of connectors can be attached while providing sufficient internal space for a powerful computational unit, memory system, multiple high performance input/output (I/O) controllers, and, any voltage conversion units which are required to provide the necessary voltage for operation of the invention.

Another feature of our invention, is that the high performance computer system provides multiple interface and expansion buses which are in addition to the traditional processor and/or memory bus. These additional separate buses can be active at the same time the processor accesses the system memory; likewise, the processor can access an expansion bus at the same time a resource on another expansion bus is accessing the system memory.

This invention supports additional input/output interfaces such as, but not limited to the following: RS-232, Universal Serial Bus (USB), RS-485, Bluetooth (a low power wireless communications standard), IEEE-1284 (Parallel Printer port), and Infrared/IrDA.

The invention supports a high-speed interface, which in the preferred embodiment, is a 10/100 Megabit Ethernet port.

The invention also supports additional optional ultra high-speed interfaces such as, but not limited to the following: 10/100 Megabit Ethernet, Gigabit Ethernet (either fiber optic or copper wire based); Scalable Coherent Interface (SCI); Fiberchannel; Myrinet™; IEEE-1394 (Firewire™); Small Computer System Interface (SCSI); Low Voltage Differential Signaling (LVDS); and multiple or bonded Ethernet ports.

It is a feature of the invention that this additional optional ultra high-speed interface is located on a separate, independent bus of the computer.

There can be a variety of means for connecting our unit to an existing host computer. After the unit has been inserted into an available drive bay, one example of a suitable connecting means would be using any of the optional ultra high-speed interfaces described earlier which are compatible with the existing host computer's interface and typically connected together through the use of a cable.

Another example of a connecting means is the use of the unit's high-speed expansion bus connected to a compatible host computer's expansion bus.

The power to operate the unit is provided in the same manner as is presently provided to peripheral hardware such as a CD drive, namely, connection to the host computers power supply.

The outer dimension of the housing unit is not the result of a simple size reduction of a general personal computer or workstation; rather it is the result of a careful elimination of specific functions often expected to be present in a general use personal computer or workstation.

In one embodiment of the invention, the standard PCI connectors, video circuitry, audio circuitry, and keyboard controller circuitry have been eliminated. In this application video, audio and keyboard circuitry are defined to include either cards which can be plugged into the motherboard or the function integrated onto the motherboard. Removal of the above-mentioned connectors and circuitry allows for enhanced computational power and more efficient use of electrical power and housing space.

Because the invention is designed as a standardized form factor housing unit which can, for example, be dimensioned for insertion and thereafter secured into a 5¼″ half-height drive bay, the invention offers designers the ability to view an entire computer, which is located in a small housing unit, as a single design resource much like an optical drive, rather than as a disparate collection of motherboard, hard drive, video interface, etc.

The combination of enclosure and computer circuitry establishes a computer standard that designers and developers can incorporate into new machines and products. This standard housing unit also facilitates easy replacement of the processing speed of older and slower motherboards found in pre-existing computers even though these motherboards are not physically replaced or removed. The invention can be slid or inserted into one of the older housing's open drive slots which is the industry standard 5¼″ half-height drive bay, much like adding a CD drive and thereafter operatively connected to a power supply and peripherals.

The outer dimension of our invention allows it to be fitted into products other than computer cases and cabinets. For example, slots capable of receiving the housing unit can be designed into such end uses as building structures, vehicles and desks. This allows for easy and predictable insertion of our computer as either a new or replacement unit.

Our invention can be utilized in various applications described as follows:

Application #1. Additional Computing Resource. In this application, our computer unit would be inserted into an existing computer enclosure drive bay and connected to an available power supply. Our invention would then be operatively connected to the existing microprocessor typically through a high speed interface such as, for example, an Ethernet, SCSI, or direct bus attachment. In this configuration, the computer unit serves as an additional computing resource to augment the computing power of the existing computer. Alternatively, the microprocessor existing in the computer enclosure can be replaced in function by our computer unit. Still another alternative, multiple computer units can be used depending upon the availability of drive slots present in the existing computer enclosure.

Application #2. Space Saving Form. Our computer unit can be utilized for a variety of applications in which a small sized computer could be used. By way of example, a computer may be required to control the environmental conditions within a building. A designer, knowing the standard size format of our computer unit can use this information in developing an efficient space for computer placement.

Application #3. Novel Personal Computer Design. In this application, a new personal computer (PC) is possible. Since the microprocessor resides in our computer unit and which is inserted into a drive bay, it can be configured to be of a plug and play design. As it becomes desirable to replace the microprocessor of the computer unit either because of failure or obsolescence, a new microprocessor, fitted in the same-type of computer unit housing can be made available. In this way, the overall PC enclosure does not have to be replaced. The benefit is that the hard drive and other hardware contained within the PC enclosure can continue to be used.

Application #4. Cluster Computing. It is possible to use a plurality of the computer units according to the invention in a compatible overall housing, thus yielding a parallel or cluster computer of much greater power. The invention's outer dimension which is sized to be inserted and secured within a drive bay, and, when coupled with the unit's high computational performance, makes it possible to construct physically small, yet extremely powerful cluster computers that occupy a limited space.

Our computer unit also has additional application when a plurality of computer units are used as servant computers of a super scalable multiprocessor system which includes a master computer and control computers. Each servant computer acts as a cell of a singular entity which can provide enhanced system performance over conventional individually networked computers. Application information is transported between servant computers by way of a standard ultra high-speed primary network which would use the computer unit's optional ultra high-speed interface. Administration information is transported by way of a secondary network which utilizes the computer unit's high-speed interface. By connecting the high-speed interface and the optional ultra high-speed interface to respective separate busses, a super scalable multiprocessor system is possible with enhanced performance characteristics. Specifically, the high-speed interface is used to communicate administration information between the master computer, control computers and servant computers. The optional ultra high-speed interface is used for linking the servant computers collectively in order to efficiently share information resulting in a large computational capability.

### BRIEF DESCRIPTION OF THE DRAWINGS

FIG. 1 is an isometric drawing with cutaway showing an embodiment of the computer unit designed according to the present invention.

FIG. 2 is an illustration of the rear view of an embodiment of the invention.

FIG. 3 is a block diagram of an embodiment of the computer system designed according to the present invention.

FIG. 4 is a block diagram of an embodiment of an optional ultra high-speed interface expansion card.

### DETAILED DESCRIPTION OF THE PREFERRED EMBODIMENT

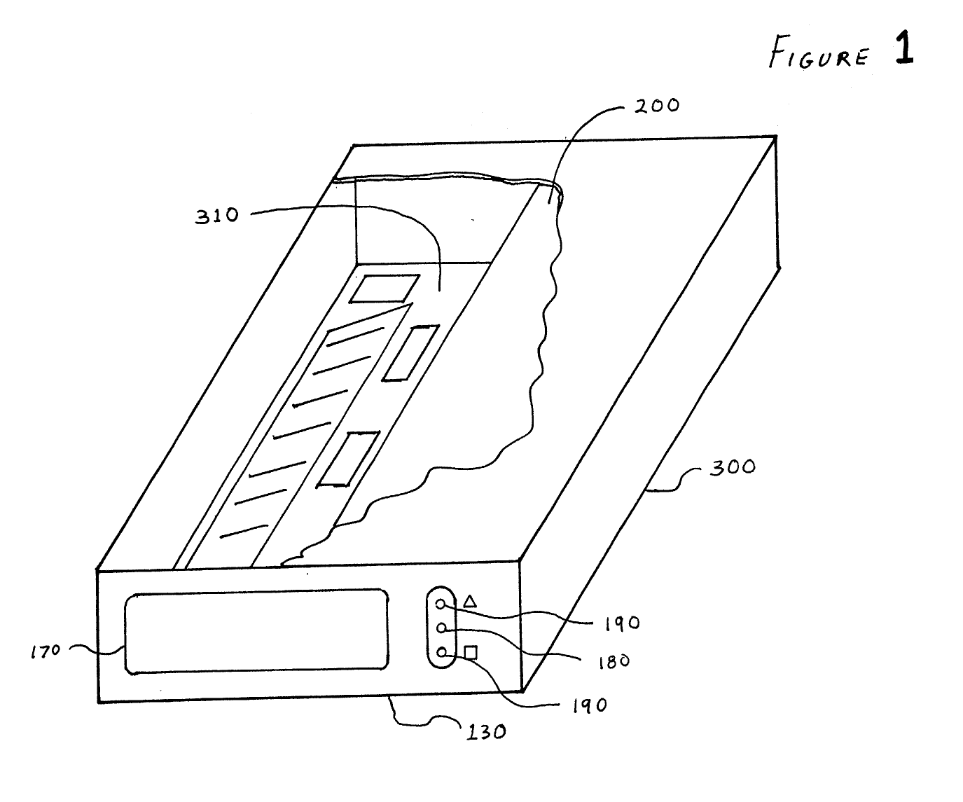

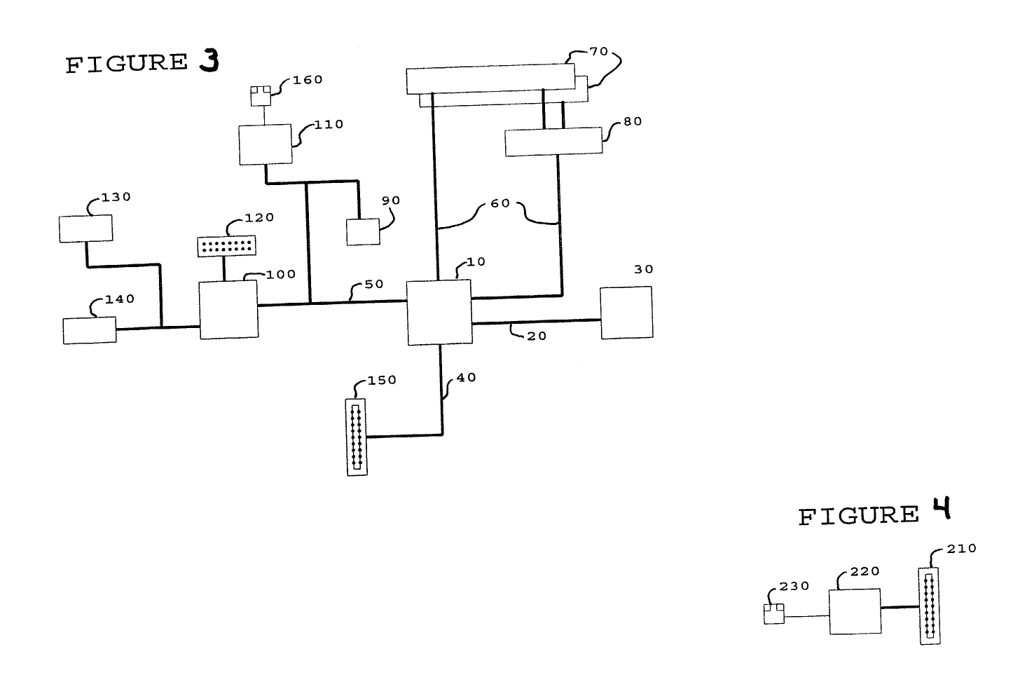

Our computer system is illustrated generally in FIG. 1 and is composed of a case 300, which can be slid into and secured to a 5¼″ half height drive bay. Within case 300 is a main printed wiring board 310 which in turn connects the individual components, an optional ultra high-speed interface expansion card 200 (also shown in block diagram form as FIG. 4) and an optional front panel 130. A multitude of components are connected to main board 310 to support the basic operation of the computer and is shown in block diagram form in FIG. 3.

Main printed wiring board 310 built with the following components: a main controller chip 10, commonly called a north bridge, which is connected to a central processor 30 via a processor bus 20; memory chips 70 which are interfaced to the main controller chip memory bus 60 through a memory interface 80; a secondary controller chip 100, commonly called a south bridge which is connected to an expansion bus 50 of the main controller chip 10; and a boot ROM system 90 which is interfaced to the main controller chip 10.

The on-board input/output peripherals are either directly connected to the main controller chip 10, or are connected through the secondary controller chip 100. The secondary controller chip 100, allows the use of industry standard mass storage devices such as for example, disk drives via an integrated drive electronics (IDE) interface 120. Secondary controller chip 100 also provides a means for supporting additional input/output interfaces designated as 140. Secondary controller chip 100 also provides a means for supporting the optional front panel, which is designated as 130.

An additional on-board peripheral is the high-speed network interface 10, which in this embodiment is a 10/100 Megabit Ethernet port. The externally accessible connector for this port is designated as 160.

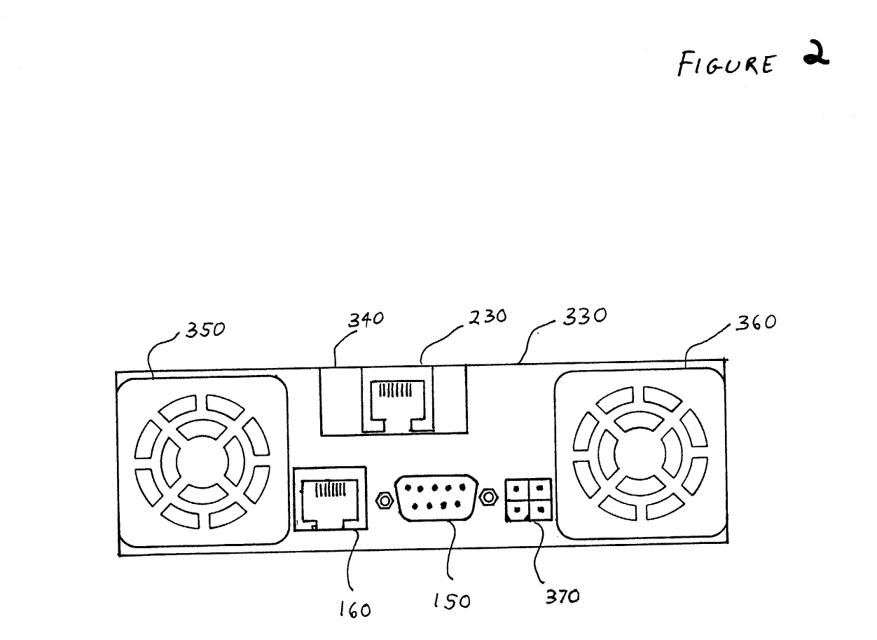

As illustrated in FIG. 2, external direct current (DC) power is supplied through a connector 370, which is accessible through a hole, located in the back panel 330. DC power is then converted to additional voltages by switching power supplies (not shown) and both the input and generated voltages are monitored by a combination of the switching supplies and the watch dog timer/reset controller (not shown). In this embodiment, the voltage conversion devices and watch dog timer/reset controller are mounted on main circuit board 310.

The computer operation is coordinated by a distributed clocking system (not shown), which in this embodiment is composed of a master clock generator, a local memory clock buffer and a dual frequency expansion bus clock buffer.

In the embodiment shown having the back panel illustrated in FIG. 2, the following external interfaces are present: a RS-232 serial port connector 150, which is part of input/output interface 140; a local area network connector 160, which is part of 110 in FIG. 3; and an ultra high-speed interface port 230, which is part of the ultra high-speed interface 220. It is to be understood that, in certain applications, the ultra high-speed interface may not be used and can therefore be considered to be an optional component.

Additional subsystems can be added to facilitate particular applications. These subsystems can be used in multiple combinations and are not limited to the particular versions or combinations chosen for the particular embodiment described which comprises a RS-232 serial interface 140 and a 10/100 Megabit Ethernet 110.

The optional front panel 130, as shown in FIG. 1, is comprised of a message display 170, switches 190 and a bi-color indicator 180. A programmable logic device (not shown) enables access to the message display 170, switches 190, indicator 180, and the serial interface 140.

Referring to FIG. 3, our invention utilizes an expansion connector 150 that is connected to a separate high bandwidth expansion bus 40 located on main controller chip 10. There is an ultra high-speed interface 220, which is located on expansion card 200 (shown in block diagram form in FIG. 4). Expansion card connector 210 connects expansion card 200 to main board 310 through connection with main board expansion connector 150.

As illustrated in FIG. 2, back panel 330 of case 300 incorporates a ‘knock out’ style opening 340 to support a variety of different connectors 230 for various high-speed interface expansion board sub-systems which are optional additions to this embodiment.

Cooling is provided by a combination of a filtered air inlet 350 and an exhaust fan (not shown) which exits air through outlet 360.

We claim:

1. A computer unit having a processor, a processor bus, a primary bridge controller, a local peripheral bus, a secondary bridge controller, an input/output bus, and a high bandwidth expansion bus, all of which are operatively connected to each other and disposed within a housing unit, the improvement comprising the housing unit sized to be inserted within a computer industry standard 5¼″ half-height drive bay.

2. The computer unit of claim 1 which can provide additional computational speed to a host computer that has a processor and at least one said available computer industry standard 5¼″ drive slot by inserting said computer unit into said drive bay and a means for operatively connecting said computer unit to said host computer.

3. The computer unit of claim 1 which can serve as a functional replacement for the processor of a host computer that has at least one said available computer industry standard 5¼″ drive slot by inserting said computer unit into said drive bay and a means for operatively connecting said computer unit to said host computer.

4. A computer comprising:
a housing having a plurality of drive slots of a uniform size, said housing further having an inner space;
video circuitry;
sound circuitry;
a power supply;
a unit housing containing a processor, a processor bus, a primary bridge controller, a local peripheral bus, a secondary bridge controller, an input/output bus, and a high bandwidth expansion bus;
wherein said unit housing is sized to be inserted into one of said drive slots and thereafter operatively connected to said video card; sound card; and said power supply.

5. The computer of claim 4 further comprising a CD rom drive unit inserted into one of said drive slots and thereafter operatively connected to said unit housing.

6. The computer of claim 4 wherein each of said plurality of drive slots are a computer industry standard 5¼″ half-height drive bay.

7. A method of utilizing a plurality of computers for cluster computing within an efficient space comprising:
providing an overall enclosure, said enclosure having a plurality of uniform size drive slots;
providing a plurality of unit housings, each of said unit housings having a processor, a processor bus, a primary bridge controller, a local peripheral bus, a secondary bridge controller, an input/output bus, and a high bandwidth expansion bus, all of which are operatively connected to each other; each of said unit housings having an outer dimension which is sized to be received into a drive slot;
inserting each of said unit housings into a respective drive slot; and,
means for connecting said unit housings operatively to one another.

8. The method of claim 7 wherein each of said plurality of drive slots is a computer industry standard 5¼″ half-height drive bay.
